(19) United States
(12) Patent Application Publication
(10) Pub. No.: US 2004/0083126 A1
(43) Pub. Date: Apr. 29, 2004

(54) Aviation traffic and revenue forecasting system

(76) Inventors: Dale V. Svenson, Irvine, CA (US); Brian G. Bousman, Huntington Beach, CA (US); Joy L. Vargo, Huntington Beach, CA (US)

Correspondence Address: WILLIAM C. ANDERSON, THE BOEING COMPANY, 15460 LAGUNA CANYON ROAD, MC 1650-7009, IRVINE, CA, 92618, US

(21) Appl. No.: 10/278,571

(22) Filed: Oct. 23, 2002

(51) Int. Cl. G06F 17/60

(52) U.S. Cl. 705/10

(57) ABSTRACT

An aviation traffic and revenue forecasting system includes an air traffic generator, an aviation communication demand and revenue generator and an enroute overflight fee system. The air traffic generator creates a population of individual aircraft flights. The aviation communication demand and revenue generator uses the population to provide estimates of communication revenue from aviation message demand data. The enroute overflight fee system estimates enroute revenue from the population.

### BACKGROUND OF THE INVENTION

1. Field of the Invention

The present invention relates generally to predicted aircraft movements and potential business revenues, and more particularly, to providing worldwide air traffic forecasts, and generating revenue estimations for ground, air and space-based air traffic management services.

2. Description of the Related Art

Global distributions of air traffic management communication demand from all aircraft classes have not heretofore been reliably generated. Thus, it has been difficult-to-impossible to determine the potential for a communications service provider to postulate a system solution or close a business case to provide improved communication required to enable safer, reliable advances in air traffic management.

Generally, current approaches (i.e. spreadsheet-based approaches) use an over-simplistic aggregate estimation of future air traffic distributions not suitable for sizing a space-based communication system solution. Thus, the tendency is to over-design a system solution, which leads to difficulty in providing such a service. Other approaches can only adequately model point-design solutions and are not flexible enough to allow trades of alternative concepts. Examples of existing models which model air traffic and/or air traffic communication services include 1) Eurocontrol's RSO Distance tool, 2) U.S. Pat. No. 6,134,500 and 3) U.S. Pat. No 6,266,610. Commercial sources of information used in SkyTrack development are also disclosed.

The RSO (Route per State Overflown) Distance Tool supports the Eurocontrol CRCO (Central Route Charges Office). This tool calculates the Enroute charges which will be charged for specific flights, based on the distance flown over European states, the weight of the aircraft and the charging factor for each particular European state. The RSO distance tool can be ordered via http://www.eurocontrol.be/dgs/activities/crco/download/files/Tool.pdf. As will be discussed below, the system of the present invention is different than the RSO distance tool in that it calculates enroute fees for all countries worldwide, not just Europe. Also, the present system simulates and calculates fees for all worldwide air traffic at once, whereas the RSO distance tool calculates fees for one flight at a time. The present system is also modifiable and extendable.

Other commercially available sources of information which the present inventors utilized in building this system were the IATA Airport & En Route Aviation Charges Manual referenced below in the description of the enroute charges system; the International Civil Aviation Organization's (ICAO's) Manual of Airport and Air Navigation Facility Tariffs Doc 7100; the internet information from Eurocontrol, ICAO and the FAA; Flight Information Region (FIR) definitions from Jeppesen; planned destinations and arrivals from the Official Airline Guide (OAG) database; and, the Boeing Commercial Market Outlook available to the public at:

http://www.boeing.com/commercial/cmo/sitemap.html.

U.S. Pat. No. 6,134,500, issued to Tang et. al., discloses a system and method for generating a minimum-cost airline flight plan from a point of origin through a set of fix points to a destination point. A set of navigation airways from the point of origin to the destination point, including predefined fix points and vectors for high altitude flight, and a set of predetermined flight planning altitudes is stored in a database. Operational data for the flight and weather data for the flight is also stored in the database, as well as station data, station approach and departure procedures, predefined flight restricted areas, and flight performance data. The predefined fix points are transformed from the Cartesian plane onto a new coordinate system based on the great circle route between the origin and the destination. Each transformed fix point is assigned an ordinal value, and an acyclic network is constructed based on the ordinal values and within a feasible search region which excludes any flight restricted areas. Using dynamic programming techniques and shortest path optimization, a minimum cost flight path from the point of origin through a plurality of predefined navigation fix points to a destination point is calculated. The minimum cost flight path calculations take into account weather data for predetermined flight planning altitudes, aircraft weight and payload data, and performance data. The system comprises a general purpose computer having a memory, a database stored in the memory and a means executing within the general purpose computer for determining the minimum cost flight path from a point of origin through a set of predefined navigation fix points to a destination point. This system, while comprising a methodology for optimizing a flight path based on cost minimization, neither allows for the generation of aviation communication demand data and potential revenue from that demand, nor does it allow computation of enroute fees for a global population of flights.

U.S. Pat. No. 6,266,610, issued to R. L. Schultz et. al., discloses a system and method of optimizing a multi-dimensional route, such as an aircraft flight path, using a lateral path optimizer and a vertical path optimizer. The lateral path is determined by searching for a path among nodes that minimizes a cost function. The vertical path is determined by reference to pre-determined data generated as a function of aircraft parameters and wind speed. The optimized route is filtered as it is being generated. The optimized route is not limited by pre-determined waypoints. The Schultz et. al. system, while involving a methodology for optimizing a flight path based on cost minimization, also does not allow for generation of aviation communication demand data and potential revenue from that demand, or allow computation of enroute fees for a global population of flights.

### SUMMARY

The present invention is an aviation traffic and revenue forecasting system. In its broad aspects it includes an air traffic generator, an aviation communication demand and revenue generator and an enroute overflight fee system. The air traffic generator creates a population of individual aircraft flights. The aviation communication demand and revenue generator uses the population to provide estimates of communication revenue from aviation message demand data. The enroute overflight fee system estimates enroute revenue from the population.

The present invention, which will be identified by the present assignee for marketing as SkyTrack™, is different than the RSO distance tool in that it is capable of calculating enroute fees for all countries worldwide, not just Europe. Also, SkyTrack™ can simulate and calculate fees for all worldwide air traffic at once, whereas the RSO distance tool calculates fees for one flight at a time. SkyTrack™ is also modifiable and extendable.

Other objects, advantages, and novel features will become apparent from the following detailed description of the invention when considered in conjunction with the accompanying drawings.

### BRIEF DESCRIPTION OF THE DRAWINGS

FIG. 1 is a schematic illustration of the aviation traffic and revenue forecasting system of the present invention.

FIG. 2 is a schematic illustration of the air traffic generator of the present invention.

FIG. 3 is a schematic illustration of the commercial flight generator of the present invention.

FIG. 4 is a schematic illustration of the non-commercial flight generator of the present invention.

FIG. 5 represents an example product of the invention which identifies the number of simultaneously operating flights vs. time of day for peak and minimum days in the Calendar Year 2007.

FIG. 6 represents an example product of the invention which identifies daily predicted revenue from a satellite-based aviation communication system serving five classes of aircraft for the Calendar Year 2007.

FIG. 7 represents an example product of the invention which represents, in tabular form, single-day predicted overflight fees for a selected population of aircraft types and countries of interest.

The same parts or elements throughout the drawings are designated by the same reference characters.

### DETAILED DESCRIPTION OF THE INVENTION

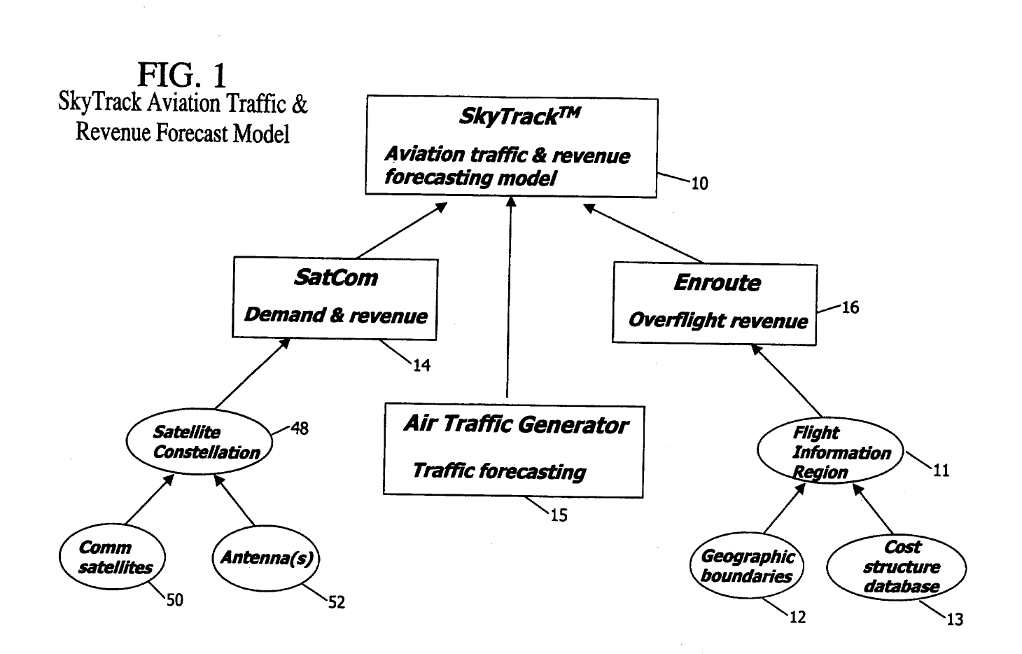

Referring now to the drawings and the characters of reference marked thereon, FIG. 1 illustrates a preferred embodiment of the aviation traffic and revenue forecasting system of the present invention, designated generally as 10. The system 10 includes an air traffic generator 15 for creating a population of individual aircraft flights. An aviation communication (“SatCom”) demand and revenue generator 14 uses the population created in 15 to provide estimates of communication revenue from aviation message demand data. An enroute overflight fee system 16 estimates enroute revenue from the population created by the air traffic generator 15. The population of individual flights provided in the air traffic generator 15 used by the system 10 could also be provided, for example, from an airline flight route planning tool or from a historic database of actual flight routes, such as would be available from civil aviation administration archives.

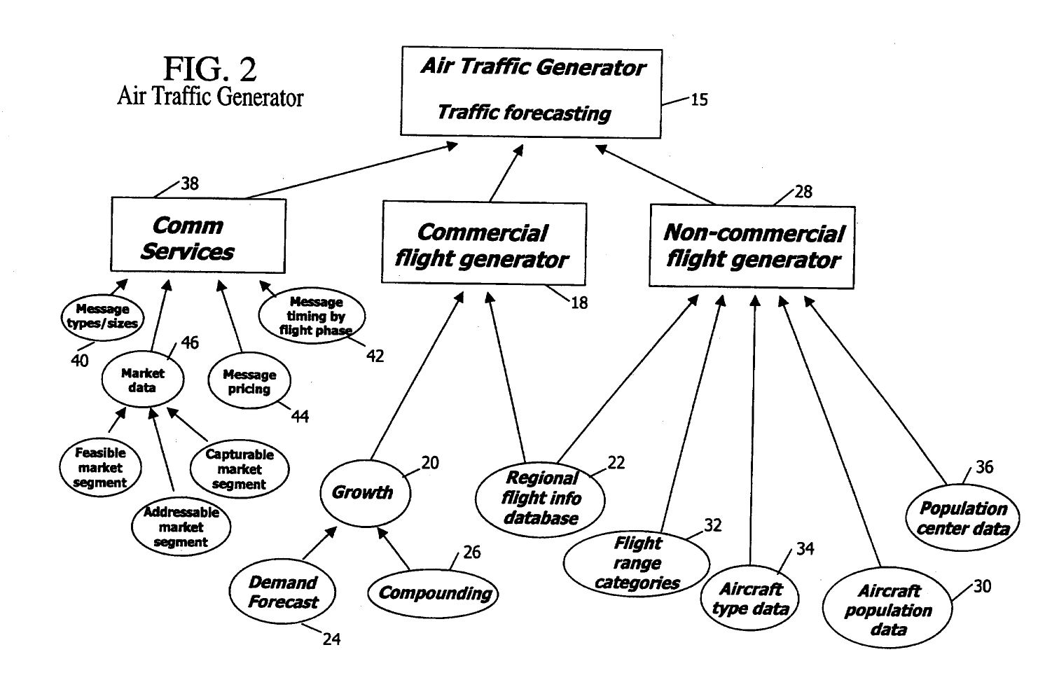

Referring now to FIG. 2, the air traffic generator 15 includes a commercial flight generator 18. The commercial flight generator 18 uses market growth data 20 and a commercial flight information database 22 for creating a commercial portion of the population.

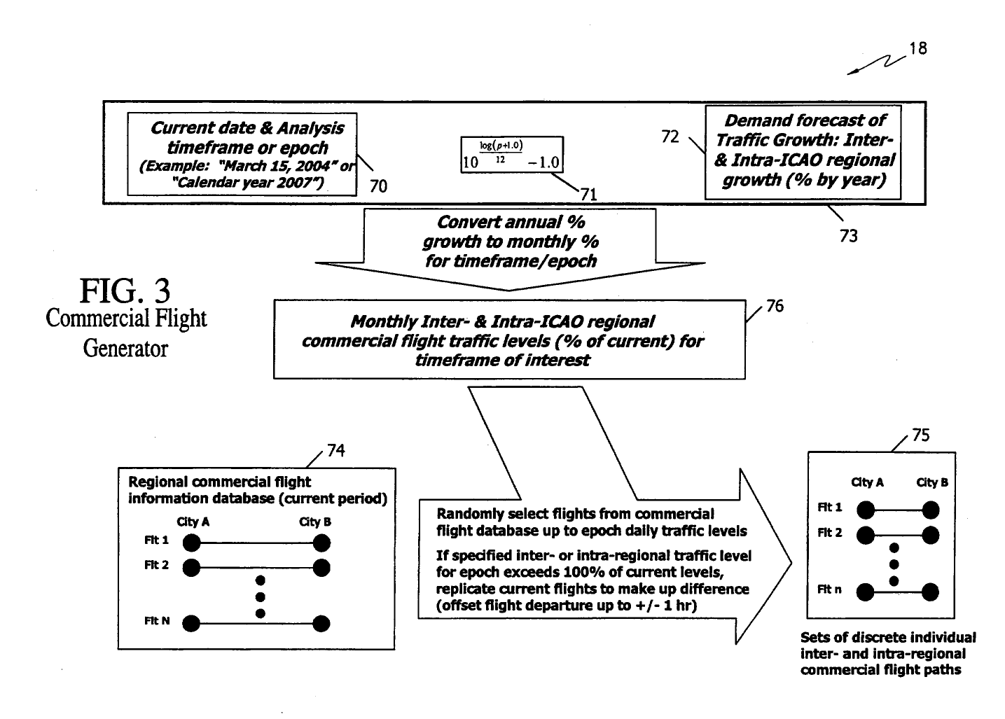

Referring now to FIG. 3, the commercial flight generator uses “current” date (date of the commercial flight information database 74) and analysis timeframe/epoch 70, market growth data 72 and a flight information database 74 for creating a commercial portion of the population. An example of the commercial flight information database 74 is the OAG Max database product, but could include similar predictive or historic databases which contain inter- and intra-regional city-to-city flight information. The inter- and intra-regional definitions are preferably provided by the ICAO regional definitions, but any regional definitions, either specific or arbitrary, may also be used. The market growth data 76 is preferably determined from demand forecast data 24 and compounding data 26 to provide monthly smoothing of the annual market growth data. The demand forecast data 72 is preferably supplied by the publicly-available Boeing Commercial Aircraft Group (BCAG) Current Market Outlook due to compatibility with ICAO regional definitions, but any aviation forecast that provides growth data matched to the desired region definitions would be sufficient. The monthly compounding data 71 could also be provided by a lookup table or by obtaining monthly-based forecasts of traffic growth rates.

Preferably, the compounding data 71 is provided by the following equation:

$$Compounding data = {10}^{\frac{log ( p + 1.0 )}{12}} - 1.0$$

wherein p is the market growth data expressed as the yearly growth percentage 72 and the result “Compounding data” 76 represents a monthly growth, but compounding could also be handled at the weekly or even daily level.

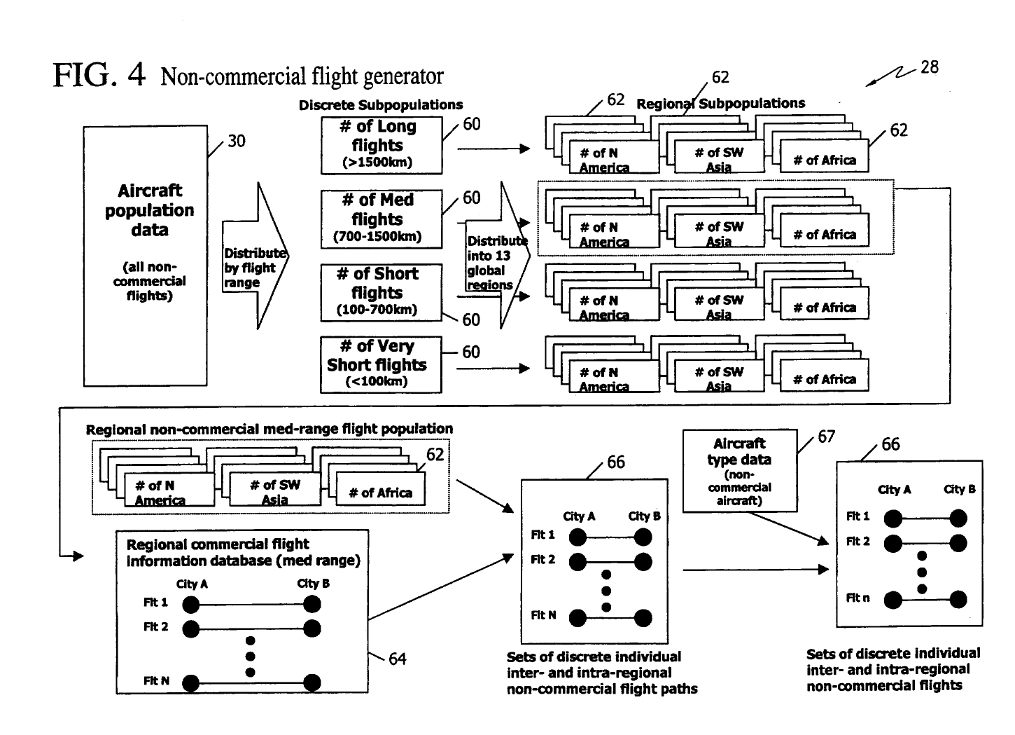

A non-commercial flight generator 28, shown in FIG. 4 of the air traffic generator 15 uses the flight information database 22 and aircraft population data 30 for creating a non-commercial portion of the population. Additionally, the non-commercial flight generator 28 preferably uses flight range categories 32, aircraft type data 34 and population center data 36 for creating the non-commercial portion of the population.

Referring now to FIG. 4, a flow diagram of the non-commercial flight generator 28 of the air traffic generator 15 is illustrated. The aircraft population data 30 is divided into discrete sub-populations 60 by utilizing flight range categories; i.e. very short flights (<100 km), short flights (100-700 km), medium flights (700-1500 km), and long flights (>1500 km). Four flight length categories were defined, but any number of categories and flight range definitions can be used. Regional sub-populations 62 are created from the discrete sub-populations 60 and ICAO flight information inter- and intra-regional definitions. The inter- and intra-regional definitions are preferably provided by the ICAO regional definitions, but any regional definitions, either specific or arbitrary, may be used. The commercial flight information database 64 is preferentially used to supply specific city pairs and flight characteristics information for each of the “aircraft” contained in the subcategories 62 to create a set of discrete flight paths 66, including flight departure timing, type of airplane, etc. for each aircraft. An example of the commercial flight information database 64 is the OAG Max database product, but a random city-pair and timing assignment process or historic flight database (obtainable from civil aviation authorities) could alternatively be used. The aircraft type data 67 is used for each flight in the set of discrete flight paths 66 to replace the aircraft characteristics from the commercial flight information database 64 with characteristics more appropriate for non-commercial type aircraft. A set of three to four specific representative non-commercial aircraft types for each flight range category 60 were selected to be assigned at random to each flight in the set of discrete flight paths 66, but alternatively, either a single aircraft type or any number of representative aircraft types could be used.

Referring again to FIG. 2, the air traffic generator 15 utilizes communication services data 38 including message type and size 40, message timing 42 and price per message 44. The communication services data 38 also includes market data 46 including the feasible market segment, addressable market segment and capturable market segment. This information is used to assign aviation communication services 38 to specific aircraft/flights created by the air traffic generator 15 for the purposes of allowing the aircraft to “request” communications messages and pay fees (“revenue”) at regular intervals throughout each flight phase. The data for the communication services data 38, message type and size 40, message timing 42 and price per message 44, market data 46 including the feasible market segment, addressable market segment and capturable market segment is formatted into computerized input data tables but alternatively could be supplied via innumerable methods, including interactively, for each flight.

Referring now again to FIG. 1, in addition to providing estimates of communication revenue from aviation message demand data, the aviation communication demand and revenue generator 14 further uses satellite constellation data 48, including satellite location data 50 and antenna pattern data 52, to estimate the portion of the demand revenue that could be captured by a satellite communication system's ability to satisfy the demand for aviation messages from the population created by the air traffic generator 15. The satellite location data 50 and antenna pattern data 52 are preferentially used to determine whether each of the flights created by the air traffic generator 15 are visible to a communication satellite at each time when the flight generates demand for a message during its phases of flight. If the aircraft is in view of an antenna 52 when it generates a message, and the satellite at its location 50 is not already saturated with message traffic, then the message is considered transmitted and revenue collected. A time-step based approach is preferentially used to determine aircraft and satellite positions and antenna pattern locations and visibility of the aircraft to the satellite(s) antenna(s), but a discrete-event approach could alternatively be used.

The enroute overflight fee system 16 is comprised of Flight Information Regions (FIRs) 11 comprised of geographical boundaries 12, and a cost structure database 13. The FIR geographical boundaries 12 are preferably procured from Jeppesen already converted into computerized map database form, although maps obtained from a variety of civil aviation authorities, ICAO or aviation services companies can be converted into an equivalent database. The cost structure database 13 is a translation of the International Air Transport Association (IATA) Airport & En Route Aviation Charges Manual into a database of computer language formulas for each FIR 11, but lookup data tables could also be used to represent cost structures for each applicable FIR 11. The IATA Airport & En Route Aviation Charges Manual used to generate the cost structure database 13 was obtained from the official source Johanna Ruttner, IATA Assistant Manager, User Charges, in Switzerland at +41 (22) 799 27 41, ruttnerj@iata.org. Alternatively, the cost structures 13 could be obtained directly from the civil aviation authorities responsible for providing air traffic control for each FIR. The enroute overflight revenue module 16 of system 10 assigns charges when aircraft in the simulation passed over each FIR. Formulas are quite diverse worldwide, using different relationships, units, time definitions, etc. However, there were five regional en route agencies of countries which shared similar formulas. For example, the Eurocontrol agency used the formula R=T*D*(Weight/50)\hat{ }0.5 where R=enroute charge, T=Unit Rate (fee), D=Great circle distance flown expressed in hundreds of kilometers taken to two decimal places, and Weight=the mean takeoff weight in metric tonnes. Using this database of enroute fee cost structures 13, the system 10 is able to estimate enroute revenue from a population of aircraft flights created by the air traffic generator 15.

Referring again to FIG. 3, which illustrates the commercial flight generator 18, commercial flights are generated over time by taking a set (i.e. a day's or year's worth) of commercial and cargo flights as captured in the Official Airline Guide (OAG) database, and growing the flights as designated by various growth forecasts, such as the Boeing Commercial Market Outlook. The annual percentages are converted to monthly percentages for a finer granularity of growth rates. Future flights are simulated by randomly selecting flights from the current flight database. If the future amount of flights predicted exceeds the current amount of flights, flights are randomly selected and replicated out of the current database to make up the difference.

Referring again now to FIG. 4, the flow diagram of the non-commercial flight generator 28 is illustrated. As noted above, the aircraft population data is divided into discrete sub-populations 60 by utilizing flight range categories; i.e. very short flights (<100 km), short flights (100-700 km), medium flights (700-1500 km), and long flights (>1500 km). Regional sub-populations 62 are created from the discrete sub-populations 60 and ICAO flight information regions. The regional sub-populations 62 are utilized along with city pairs 64 from the regional flight information database 22 to create the population of individual aircraft flights 66.

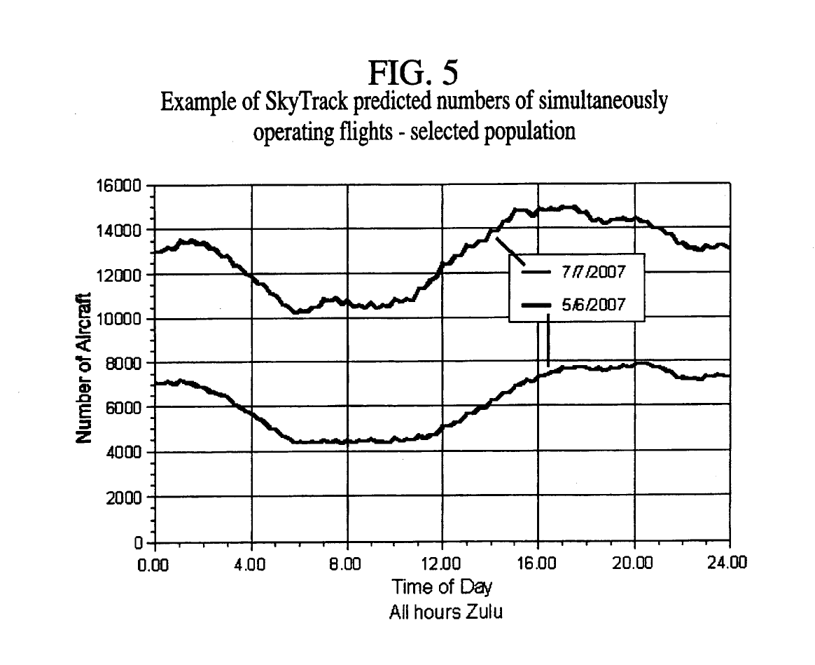

An example of the implementation of this system 10 is illustrated in FIGS. 5, 6, and 7 where a set of traffic and revenue analyses were conducted for during a one-year period (Calendar Year 2007). A selected set of commercial air carriers (passenger and cargo aircraft) and a selected subset of the projected in-flight populations of non commercial aircraft (military, general aviation, rotorcraft/helicopters) were assumed to form a pool of available aircraft/flights. Flights using this population information were generated and flown in the computer for every day within the calendar year to generate both communication message demand and fees from overflight of controlled airspace.

FIG. 5 illustrates the number of simultaneously operating flights during a 24-hour period for highest population day (Jul. 7, 2007) and for the lowest population day (May 6, 2007) during the analysis timeframe, which illustrates the highest and lowest levels of simultaneous aircraft a satellite-based aviation communication system would need to accommodate and what time of day those peaks/valleys would occur.

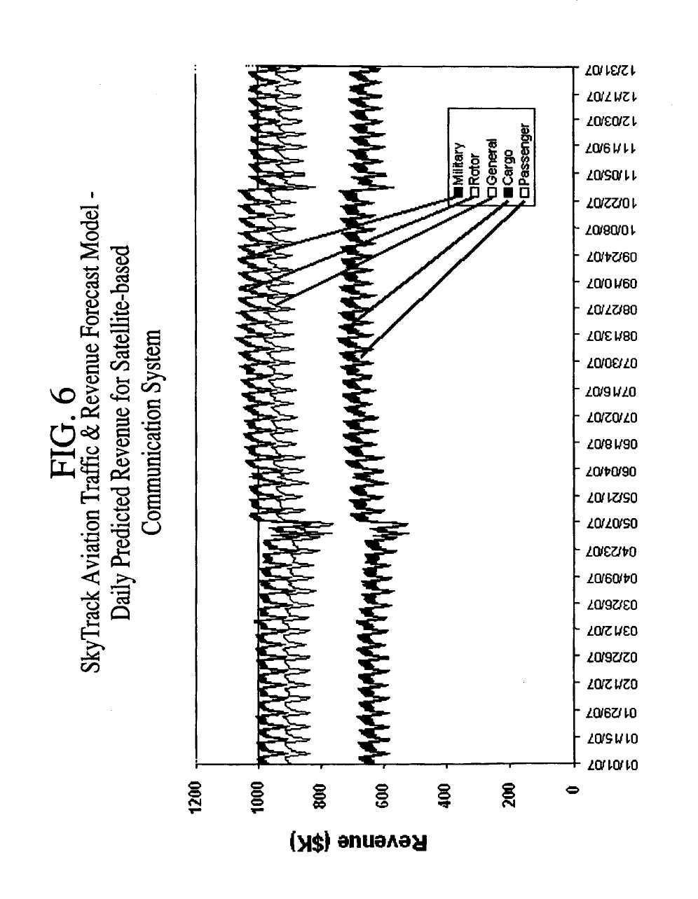

FIG. 6 illustrates the introduction into system 10 of a notional constellation of communication satellites and fixed, nadir-pointing antenna patterns to accommodate a portion of the potential message traffic demand generated by the daily flights. The message demand is based on the number of aircraft in the population which could feasibly equip for each message type, would choose to equip, and would choose to equip from a specific service provider. Given the above assumptions, FIG. 6 provides the system 10 projected daily revenue contribution from each of the five classes of aircraft (described above) for the entire year in stack chart form, indicating message revenue would be roughly $1M US dollars per day from all aircraft (example).

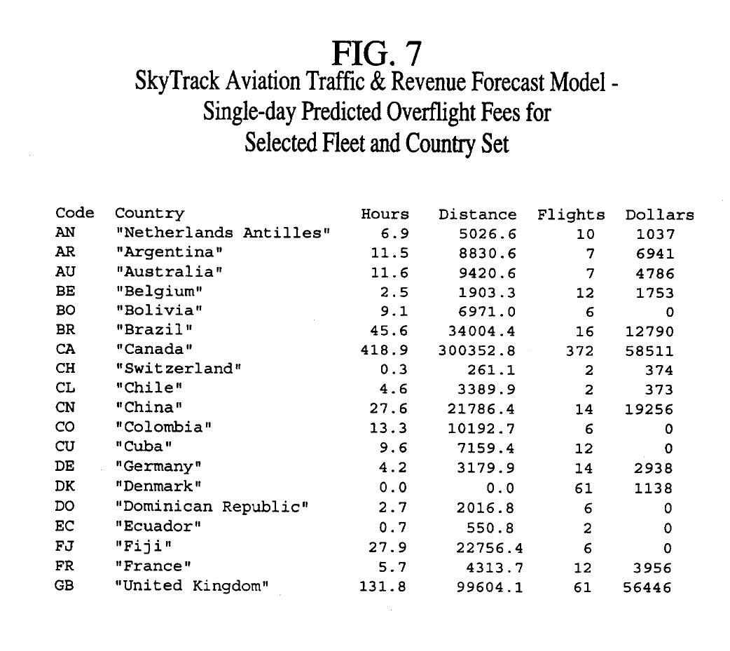

FIG. 7 shows a tabular output of enroute fee and aircraft data for a selected fleet over a specified list of countries. The cumulative hours of flight, distance flown and enroute fees (converted to US dollars) are listed per country for a single day, as well as total number of aircraft that flew over each country that day.

Obviously, many modifications and variations of the present invention are possible in light of the above teachings. It is, therefore, to be understood that within the scope of the appended claims, the invention may be practiced otherwise than as specifically described.

What is claimed and desired to be secured by Letters Patent of the United States is:

1. An aviation traffic and revenue forecasting system, comprising:
a) an air traffic generator for creating a population of individual aircraft flights;
b) an aviation communication demand and revenue generator for using said population to provide estimates of communication revenue from aviation message demand data; and,
c) an enroute overflight fee system for estimating enroute revenue from said population.

2. The aviation traffic and revenue forecasting system of claim 1, wherein said air traffic generator, comprises:
a) a commercial flight generator for using market growth data and a flight information database for creating a commercial portion of said population; and,
b) a non-commercial flight generator for using said flight information database and aircraft population data for creating a non-commercial portion of said population,
wherein said commercial portion, said non-commercial portion and commercial services data are utilized to create said population.

3. The aviation traffic and revenue forecasting system of claim 1, wherein said air traffic generator, comprises:
a) a commercial flight generator for using market growth data and a flight information database for creating a commercial portion of said population; and,
b) a non-commercial flight generator for using said flight information database, aircraft population data, flight range categories, aircraft type data and population center data for creating a non-commercial portion of said population,
wherein said commercial portion, said non-commercial portion and commercial services data are utilized to create said population.

4. The aviation traffic and revenue forecasting system of claim 1, wherein said air traffic generator, comprises:
a) a commercial flight generator for using market growth data and a flight information database for creating a commercial portion of said population, said market growth data being determined from demand forecast data and compounding data; and,
b) a non-commercial flight generator for using said flight information database and aircraft population data for creating a non-commercial portion of said population,
wherein said commercial portion, said non-commercial portion and commercial services data are utilized to create said population.

5. The aviation traffic and revenue forecasting system of claim 4, wherein said compounding data is provided by the following equation:
$$Compounding data = {10}^{\frac{log ( p + 1.0 )}{12}} - 1.0$$
wherein p is the market growth data expressed as the yearly growth percentage.

6. The aviation traffic and revenue forecasting system of claim 4, wherein said air traffic generator utilizes communication services data comprising message type, message size, message timing and price per message.

7. The aviation traffic and revenue forecasting system of claim 4, wherein said air traffic generator utilizes communication services data comprising market data comprising feasible, addressable and capturable market segments.

8. The aviation traffic and revenue forecasting system of claim 1, wherein said enroute overflight fee system for estimating enroute revenue from said population utilizes Flight Information Regions (FIRs) and a cost structure database, said population generating enroute revenue based on aircraft weight and distance flown.

9. The aviation traffic and revenue forecasting system of claim 1, wherein said aviation communication demand and revenue generator further uses satellite constellation data comprising: satellite location data and antenna pattern data.

10. The aviation traffic and revenue forecasting system of claim 3, wherein said non-commercial flight generator determines said population of individual aircraft flights, utilizing the steps comprising:
a) dividing said aircraft population data into discrete sub-populations by utilizing said flight range categories;
b) creating regional sub-populations from said discrete sub-populations and ICAO flight information regions; and,
c) utilizing said regional sub-populations and city pairs from said regional flight information database to create said population of individual aircraft flights.

11. The aviation traffic and revenue forecasting system of claim 1, wherein said air traffic generator creates a worldwide population of individual aircraft flights.

12. An aviation traffic and revenue forecasting system, comprising:
a) an air traffic generator for creating a population of individual aircraft flights, said air traffic generator, comprising;
i) a commercial flight generator for using market growth data and a flight information database for creating a commercial portion of said population, said market growth data being determined from demand forecast data and compounding data; and,
ii) a non-commercial flight generator for using said flight information database and aircraft population data for creating a non-commercial portion of said population,
wherein said commercial portion, said non-commercial portion and commercial services data are utilized to create said population, said commercial services data comprising message type, message size, message timing, price per message and feasible, addressable and capturable market segments;
b) an aviation communication demand and revenue generator for using said population to provide estimates of communication revenue from aviation message demand data; and,
c) an enroute overflight fee system for estimating enroute revenue from said population.

13. The aviation traffic and revenue forecasting system of claim 12, wherein said non-commercial flight generator further comprises utilizing flight range categories, aircraft type data and population center data for creating said non-commercial portion of said population.

14. The aviation traffic and revenue forecasting system of claim 12, wherein said compounding data is provided by the following equation:
$$Compounding data = {10}^{\frac{log ( p + 1.0 )}{12}} - 1.0$$
wherein p is the market growth data expressed as the yearly growth percentage.

15. The aviation traffic and revenue forecasting system of claim 12, wherein said enroute overflight fee system for estimating enroute revenue from said population utilizes Flight Information Regions (FIRs) and a cost structure database, said population generating enroute revenue based on aircraft weight and distance flown.

16. The aviation traffic and revenue forecasting system of claim 12, wherein said aviation communication demand and revenue generator further uses satellite constellation data comprising: satellite location data and antenna pattern data.

17. The aviation traffic and revenue forecasting system of claim 12, wherein said non-commercial flight generator determines said population of individual aircraft flights, utilizing the steps comprising:
a) dividing said aircraft population data into discrete sub-populations by utilizing said flight range categories;
b) creating regional sub-populations from said discrete sub-populations and ICAO flight information regions; and,
c) utilizing said regional sub-populations and city pairs from said regional flight information database to create said population of individual aircraft flights.

18. The aviation traffic and revenue forecasting system of claim 12, wherein said air traffic generator creates a worldwide population of individual aircraft flights.

19. An aviation traffic and revenue forecasting system, comprising:
a) an air traffic generator for creating a population of individual aircraft flights, said air traffic generator, comprising;
i) a commercial flight generator for using market growth data and a flight information database for creating a commercial portion of said population; and,
ii) a non-commercial flight generator for using said flight information database, aircraft population data, flight range categories, aircraft type data and population center data for creating a non-commercial portion of said population,
wherein said commercial portion, said non-commercial portion and commercial services data are utilized to create said population, said commercial services data comprising message type, message size, message timing, price per message and feasible, addressable and capturable market segments;
b) an aviation communication demand and revenue generator for using said population to provide estimates of communication revenue from aviation message demand data; and,
c) an enroute overflight fee system for estimating enroute revenue from said population, said enroute overflight fee system utilizing Flight Information Regions (FIRs) and a cost structure database, said population generating enroute revenue based on aircraft weight and distance flown.

20. The aviation traffic and revenue forecasting system of claim 19, wherein said market growth data is determined from demand forecast data and compounding data.

21. The aviation traffic and revenue forecasting system of claim 19, wherein said aviation communication demand and revenue generator further uses satellite constellation data comprising: satellite location data and antenna pattern data.

22. The aviation traffic and revenue forecasting system of claim 19, wherein said non-commercial flight generator determines said population of individual aircraft flights, utilizing the steps comprising:
a) dividing said aircraft population data into discrete sub-populations by utilizing said flight range categories;
b) creating regional sub-populations from said discrete sub-populations and ICAO flight information regions; and,
c) utilizing said regional sub-populations and city pairs from said regional flight information database to create said population of individual aircraft flights.

23. The aviation traffic and revenue forecasting system of claim 19, wherein said air traffic generator creates a worldwide population of individual aircraft flights.
